(19) United States
(12) Patent Application Publication
(10) Pub. No.: US 2025/0378396 A1
(43) Pub. Date: Dec. 11, 2025

(54) ENHANCED ACCESSIBILITY FOR IN-STORE SHOPPING

(71) Applicant: Dell Products, L.P., Round Rock, TX (US)

(72) Inventors: Ofir Ezrielev, Be'er Sheva (IL); Shaul Dar, Petach Tikva (IL); Rasa Raghavan, Verona, WI (US)

(21) Appl. No.: 18/736,054

(22) Filed: Jun. 6, 2024

(51) Int. Cl. G06Q 10/047; G06Q 30/0601

(52) U.S. Cl. CPC G06Q 10/047; G06Q 30/0633; G06Q 30/0639

(57) ABSTRACT

Architectures and techniques are described that can provide enhanced accessibility for in-store shoppers such as a shopper with a vision impairment. For example, the disclosed techniques can operate to dynamically generate a shopping list from freeform (e.g., speech) item descriptions. The shopping list derived from the item descriptions can include actual, specific product identifiers for products offered for sale at a physical store location. Furthermore, an associated in-store navigation route to products of the shopping list can be generated based on any one of several different collection techniques or approaches.

### BACKGROUND

Certain products exist in the marketplace that are designed to improve accessibility, such as accessibility for persons that are blind or have low vision. One example that is specifically directed to the blind and low vision community is ‘Seeing AI’ which is to an artificial intelligence application developed by Microsoft for iPhone operating system (iOS) and other mobile device operating systems. Seeing AI leverages a camera of the mobile device and uses optical character recognition (OCR) or other object recognition models to identify text or an object within the field of view of the camera device. The text or the objects are then audibly narrated or described. Other accessibility products include ‘Aira’, which connects people who are blind or low vision to professional visual interpreters for secure access to visual information captured by a camera feed; and ‘Be My Eyes’ which connects blind and low-vision users who want sighted assistance with volunteers via a camera feed.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram illustrating operation of various example accessibility applications in accordance with certain embodiments of this disclosure;

FIG. 2 depicts a schematic block diagram illustrating an example device that can provide enhanced accessibility and/or improved experiences for in-store shoppers in accordance with certain embodiments of this disclosure;

FIG. 3 depicts a schematic block diagram illustrating an example structure of the digital twin in accordance with certain embodiments of this disclosure;

FIG. 4 depicts a schematic block diagram illustrating an example device that can provide enhanced accessibility for in-store shoppers by dynamically generating a shopping list and an associated in-store navigation route to products of the shopping list in accordance with certain embodiments of this disclosure;

FIG. 5 depicts a schematic block diagram illustrating additional aspects or elements of the example device that can provide enhanced accessibility for in-store shoppers by dynamically generating a shopping list and an associated in-store navigation route to products of the shopping list in accordance with certain embodiments of this disclosure;

FIG. 6A depicts a schematic block diagram illustrating several potential examples of a selected technique in accordance with certain embodiments of this disclosure;

FIG. 6B depicts a schematic block diagram illustrating several potential examples of certain information that can be presented prior to presentation of the directions in accordance with certain embodiments of this disclosure;

FIG. 7 illustrates an example method that can provide enhanced accessibility for in-store shoppers by dynamically generating a shopping list and an associated in-store navigation route to products of the shopping list in accordance with certain embodiments of this disclosure;

FIG. 8 illustrates an example method that can provide for additional elements or functionality relating to providing enhanced accessibility for in-store shoppers by dynamically generating a shopping list and an associated in-store navigation route to products of the shopping list in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

In certain domains, accessibility for many groups, among them people with low or no vision, is lacking. One of the industries where the experience for low/no vision people is still ill-served is retail. While blind or low vision people sometimes want a full shopping experience, including touching or physically interacting with products before buying, there are still issues with orientation in the store and with identification of products, which require low/no vision customers to request help from others rather than being completely independent as they deserve to be.

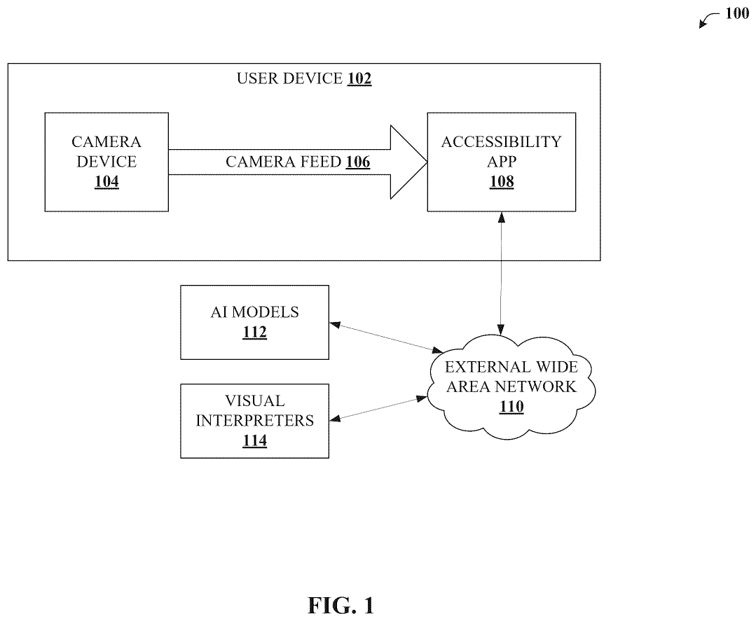

While certain products exist in the market such as Seeing AI, Aira, or Be My Eyes, in the context of retail shopping, these products can be insufficient. To provide additional context, consider FIG. 1. FIG. 1 shows a schematic block diagram 100 illustrating operation of various example accessibility applications in accordance with certain embodiments of this disclosure.

In that regard, user device 102 is depicted, typically a smart phone or the like. User device 102 can comprise a camera device 104 that, when activated, produces camera feed 106. As depicted, camera feed 106 can be provided to an accessibility app 108 such as an app relating to Seeing AI, Aira, or Be My Eyes,

In response, camera feed 106 can be provided to some external wide area network 110 such as a cellular network. In the context of Seeing AI, camera feed 106 can be input to certain AI models 112 (e.g., OCR model an or object recognition model) in order to generate output that identifies text or other objects. This output can be provided to accessibility app 108, which can then audibly orate the output. In the context of Aira or Be My Eyes, camera feed 106 can be provided to visual interpreters 114, who can then provide guidance or descriptions.

While these accessibility apps 108 can be useful for people with no or low vision, in the context of in-store or retail shopping, certain drawbacks or difficulties can arise. For example, AI models 112 can sometimes be slow to respond or significant connection latency can exist, which can cause frustration for an operator of user device 102. Moreover, camera feeds 106 that are intended to capture information (e.g., QR codes) about a particular product may frequently fail, particularly when the product comprises a shiny material. Moreover, accessibility app 108 relies on external wide area network 110, e.g., a cellular network, which commonly exhibits low or no service periods. Furthermore, particularly when visual interpreters 114 are relied on, it is observed that remote human assistance may not always be available when needed.

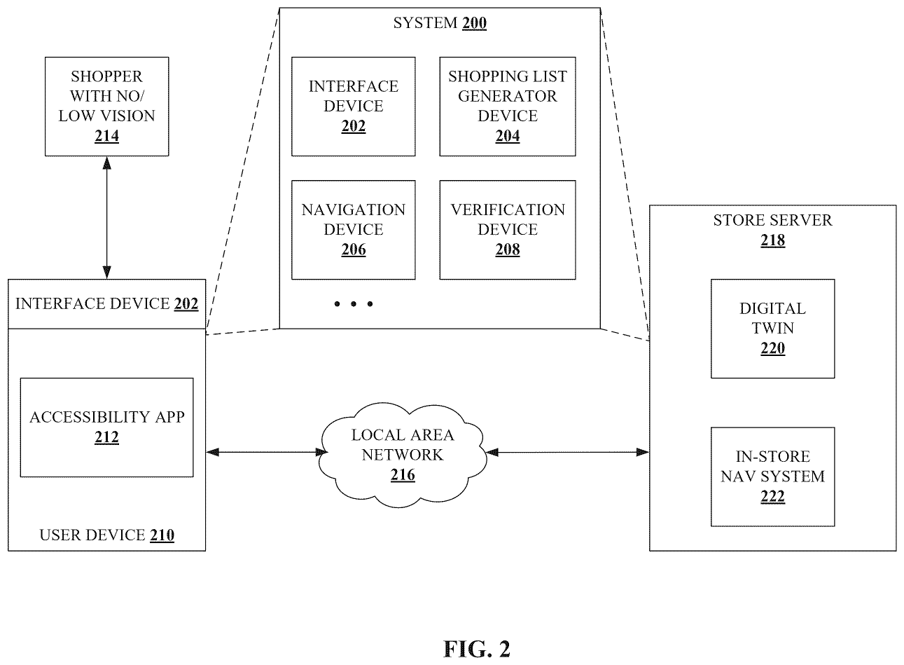

To overcome these difficulties and to other related ends, the disclosed techniques take an entirely different approach than previous accessibility apps 108. For example, unlike accessibility apps 108, the disclosed techniques can be specifically tailored for shopping experiences and need not rely on connection with external wide area network 110, which can be a source of poor experiences. The disclosed techniques can provide a seamless accessibility experience for shoppers, particularly those with low or no vision, which is further detailed in connection with FIG. 2 and other drawings.

### Example Systems

With reference now to FIG. 2, a schematic block diagram is depicted illustrating an example device 200 that can provide enhanced accessibility and/or improved experiences for in-store shoppers in accordance with certain embodiments of this disclosure. In that regard, system 200 can more effectively serve shopper 214 with no/low vision.

System 200 can comprise all or a portion of the following: interface device 202, shopping list generator device 204, navigation device 206, verification device 208, or any other suitable device or element, which are further detailed below. In some embodiments, all or a portion of system 200 can reside in user device 210. In some embodiments, all or a portion of system 200 can reside in store server 218. In some embodiments, a first portion (e.g., interface device 202) of system 200 can reside in user device 210 and a second portion of system 200 (e.g., shopping list generator device 204, navigation device 206, verification device 208) can be hosted by store server 218.

Initially, a shopper (e.g., shopper 214 with no/low vision) can start an associated shopping experience by inputting an item list to accessibility app 212, which can be executed by user device 210. Accessibility app 212 can be specifically configured to interface with system 200. User device 210 can be a smart phone device, a tablet device, a wearable device, or another suitable computing device, particularly any device that can be utilized in connection with in-store shopping or the like. Advantageously, user device 210 and/or accessibility app 212 can interface with store server 218 and/or certain elements of system 200 situated at store server 218 via local area network 216. In contrast to previous solutions associated with accessibility app 108 that rely on external wide area network 110, local area network 216 can be more reliable with lower latency and/or less susceptible to external interference or disruptions.

The item list can be input in the form of free or generic text (e.g., as opposed to a specific product name/description), for example, “salad dressing”. The item list can be input via interface device 202, which can be configured especially for a person with vision impairment. For example, interface device 202 can be configured to enhance a non-visual aspect of communication to mitigate the vision impairment. Hence, for example, the item list can be input according to a Braille form or verbally articulated and thereafter converted or transcribed to a standardized text format.

The standardized text of the item list can then be input to shopping list generator device 204 that can match the generic text (e.g., “salad dressing”) to a product identifier of an actual product for sale at a physical store location (e.g., “12 ounce bottle of value brand ranch salad dressing”). For example, one or more item(s) from the item list can be iteratively matched to an associated product identifier by a large language model (LLM) or another suitable artificial intelligence (AI) model.

In some cases, particularly when the item description data is generic and/or multiple store products potentially fit the item description, the matching model can match freeform or generic item description data based on known user preferences, history, or another (e.g., default) selection criterion. In other embodiments, additional information (e.g., additional selection criterion) can be requested from shopper 214. Regardless, such can be used to select based on, e.g., fair trade criterion, organic certified criterion, sugar-free criterion, a price criterion, a preferred brand criterion, an allergy or health-related criterion, and so on.

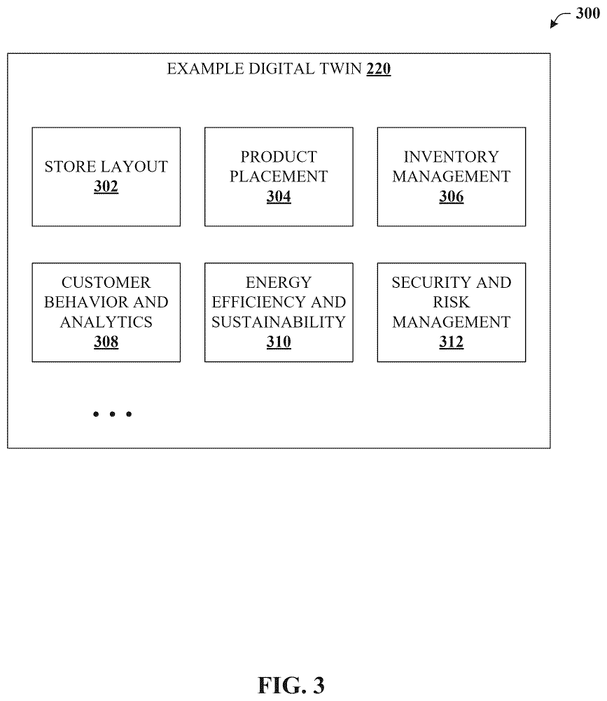

In order to perform the matching, shopping list generator device 204 (and/or an associated LLM or the like) can leverage a digital twin 220 that can be hosted on store server 218. Digital twin 220 can be indicative of a virtual or digital model that mirrors the physical store, including its layout, products, and services. By using digital twin 220, retailers can create a more personalized and engaging shopping experience for customers, while also improving operational efficiency and reducing costs, which is further explained below. Additional detail relating to digital twin 220 can be found in connection with FIG. 3.

While still referring to FIG. 2, but turning now as well to FIG. 3, a schematic block diagram 300 is depicted illustrating an example structure of the digital twin 220 in accordance with certain embodiments of this disclosure. As illustrated, digital twin 220 can comprise store layout data 302, product placement data 304, and/or inventory management data 306 that can, respectively, indicate how a store is arranged, where in the store products are located, and associated product inventory levels. Hence, digital twin 220 can be leveraged in order to aid, analyze, or optimize various aspects of the in-store experience. For example, digital twin can 220 can aid in connection with overall store layout and navigation. Digital twin 220 can help retailers design and optimize store layouts to improve customer flow, reduce congestion, and enhance the overall shopping experiences.

As another example, digital twin 220 can aid in product placement and inventory management. For instance, digital twin 220 can simulate product placement and inventory levels to optimize stock levels, reduce waste, and improve customer satisfaction. Furthermore, digital twin 220 can aid in customer behavior and analytics 308. For instance, digital twin 220 can analyze customer behavior, such as foot traffic patterns, dwell times, and purchase habits, to inform marketing strategies and improve customer engagement.

In some embodiments, digital twin 220 can aid in energy efficiency and sustainability 310. For instance, digital twin 220 can optimize energy consumption and reduce waste by simulating energy usage and identifying areas for improvement. In some embodiments, digital twin 220 can aid in security and risk management 312. For instance, digital twin 220 can help retailers identify potential security risks and optimize security measures to ensure a safe and secure shopping environment.

While digital twin 220 can provide significant advantages for a retailer, particular interest in connection with the disclosed techniques can be directed to product data, product location data, and product availability, which can be determined based on store layout data 302, product placement data 304, and/or inventory management data 306.

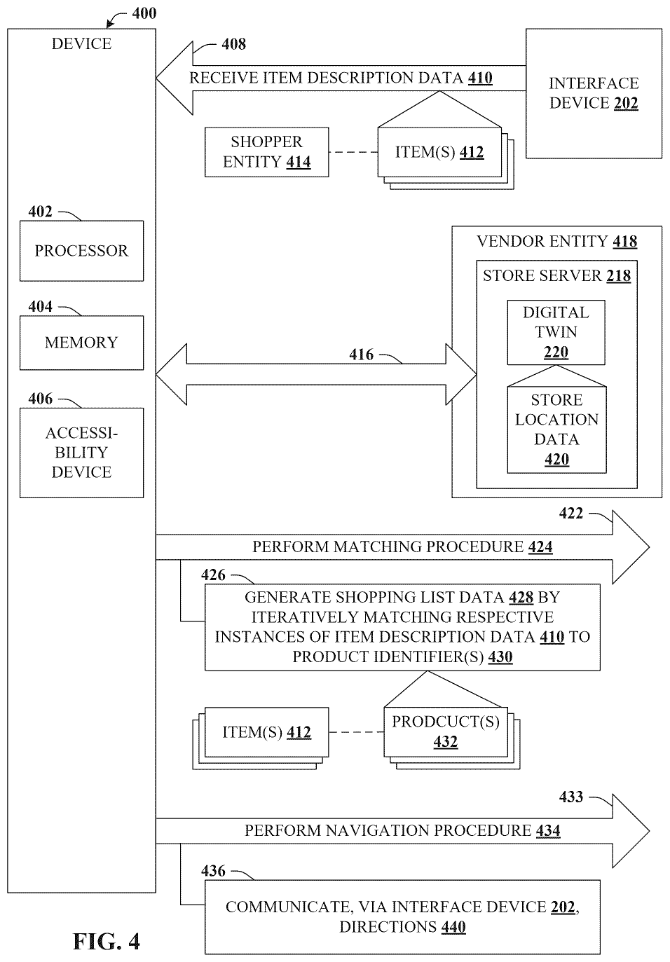

Still referring to FIG. 2 and the discussion of shopping list generator 204, a shopping list can be generated. The shopping list can comprise at least one product identifier associated with an actual product for sale at the store location that was determined from an associated item description input to shopping list generator 204. Additional detail relating to aspects or elements associated with shopping list generator 204, navigation device 206, and verification device 208 can be found in connection with FIG. 4 and subsequent drawings.

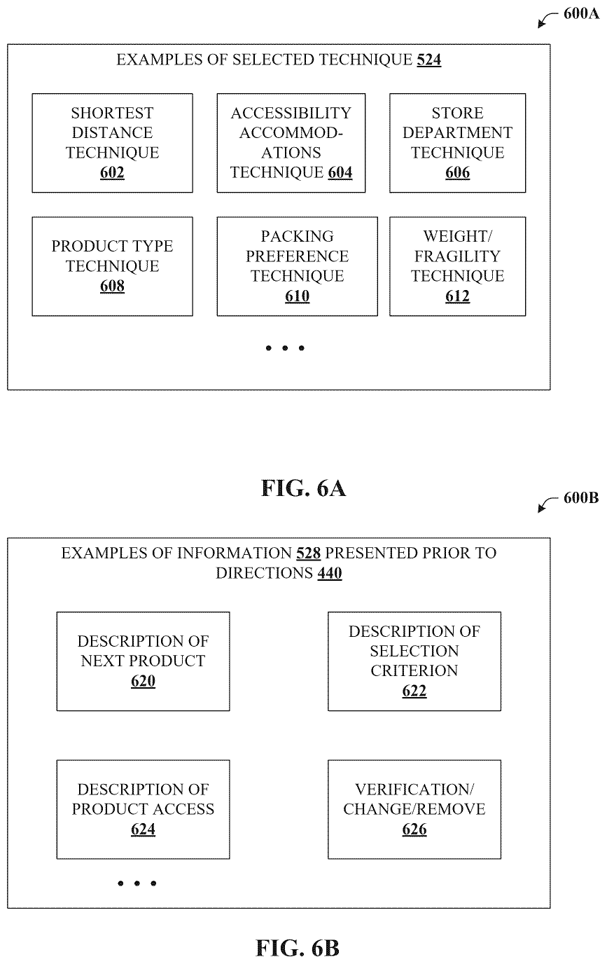

Once the shopping list is derived, navigation device 206 can be leveraged. For example, the location(s) of various products indicated by the shopping list can be identified from digital twin 220 and a collection route can be generated. The collection route can be in accordance with one or more algorithms or techniques that are further detailed in connection with FIG. 6A.

In some embodiments, guidance or navigation to a particular product can be provided, e.g., via interface device 202, in an audible or tactile manner that can be advantageous for shopper with no/low vision 214. For example, a wearable device (e.g., a smart watch) can be configured to vibrate in a defined manner to facilitate the navigation.

In some embodiments, guidance or navigation can leverage an in-store navigation system 222. In-store navigation system 222 can relate to any suitable location-based technology to improve in-store navigation for shoppers such as shopper 214. One example of in-store navigation system 222 can be Walmart's indoor navigation system. Another example can be to utilize store cameras or other tracking devices or equipment to determine a location of shopper 214 such as for example, radio frequency identification (RFID) techniques, a global positioning satellite (GPS) system techniques, triangulation/trilateration of radio frequency signals (e.g., wireless fidelity (WIFI)) techniques, and so on.

In some embodiments, when initiating a route branch to the next product on the shopping list, the product can be named (e.g., audibly) for shopper 214, who can then be provided the opportunity to verify the intent to collect that particular product or whether shopper 214 otherwise desires to change or remove the product, which along with other advantageous elements is further detailed in connection with FIG. 6B.

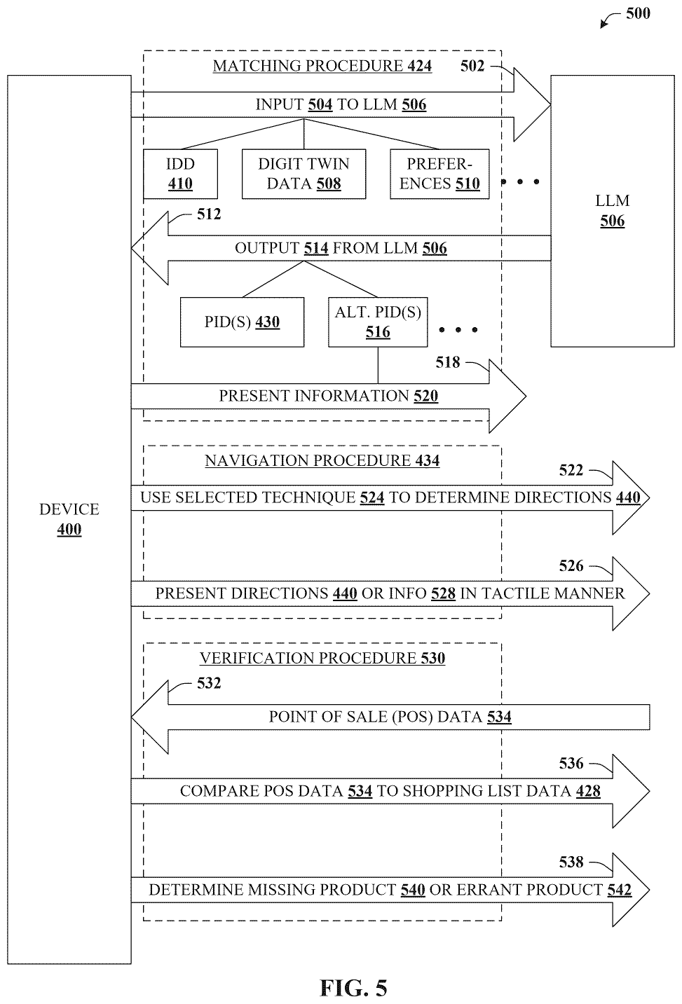

After the collection process is completed and shopper 214 proceeds to checkout, the collected products can be verified by verification device 208. For example, the collected products can be verified to match the products listed in the shopping list. In some embodiments, an alert can be raised if there are discrepancies (e.g., a product on the shopping list was not processed at the point of sale and/or a different product not on the shopping list was accidentally selected by shopper 214). Hence, shopper 214 can further trust that they have indeed obtained the desired products, which is further detailed in connection with verification procedure 530 of FIG. 5. Additional detail relating to aspects or elements associated with shopping list generator 204, navigation device 206, and verification device 208 can be found in connection with FIG. 4 and subsequent drawings.

With reference now to FIG. 4, a schematic block diagram is depicted illustrating an example device 400 that can provide enhanced accessibility for in-store shoppers by dynamically generating a shopping list and an associated in-store navigation route to products of the shopping list in accordance with certain embodiments of this disclosure. In that regard, device 400 can comprise all or a portion of system 200. In some embodiments, device 400 can be situated in whole or in part in a user device (e.g., user device 210). In some embodiments, all or a portion of device 400 can be deployed to a server device associated with a store location such as store server 218.

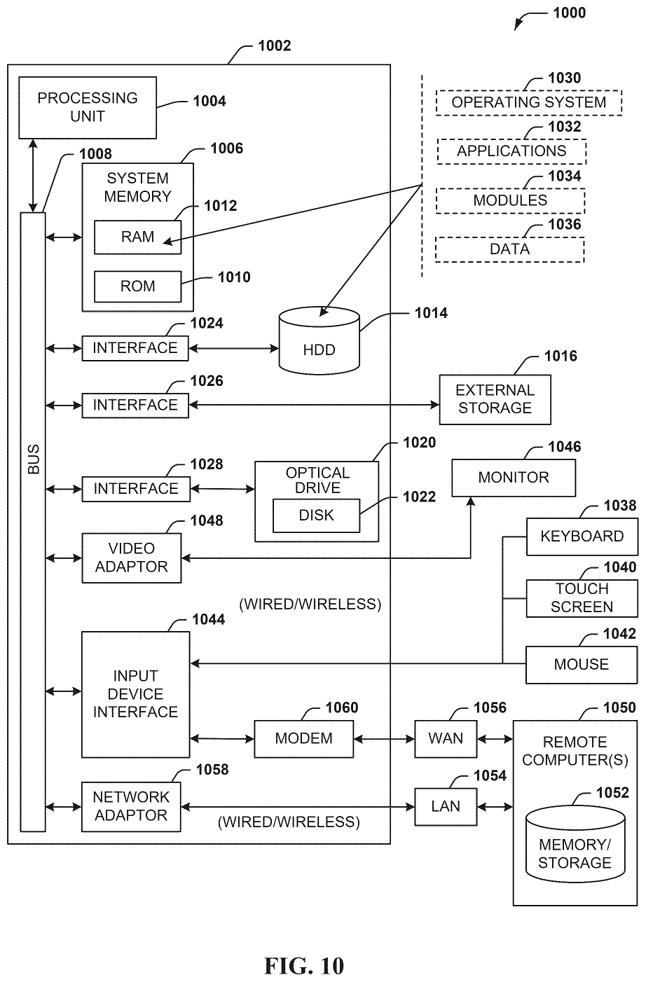

Device 400 can comprise at least one processor 402 that, potentially along with accessibility device 406, can be specifically configured to perform functions associated with generating a shopping list for a product, navigation to an in-store location of the product, and/or verification of a point of sale transaction for the product. Device 400 can also comprise at least one memory 404 that stores executable instructions that, when executed by the at least one processor 402, can facilitate performance of operations. Processor(s) 402 can be a hardware processor having structural elements known to exist in connection with processing units or circuits, with various operations of processor 402 being represented by functional elements shown in the drawings herein that can require special-purpose instructions, for example, stored in memory 404 and/or accessibility device 406. Along with these special-purpose instructions, processor 402 and/or accessibility device 406 can be a special-purpose device. Further examples of the memory 404 and processor 402 can be found with reference to FIG. 10. It is to be appreciated that device 400 or computer 1002 can represent a server device or a client/user device of a network or data services platform and computer 1002 can be used in connection with implementing one or more of the systems, devices, or components shown and described in connection with FIG. 4 and other figures disclosed herein.

As illustrated at reference numeral 408, device 400 can receive at least one instance of item description data 410. As depicted, item description data 410 can be received (e.g., directly or indirectly) via interface device 202, which, as detailed can be configured to especially for communication with a person having a vision impairment. Thus, for example, interface device 202 can be configured to provide or enhance a non-visual aspect of the communication in order to mitigate the vision impairment. A given instance of item description data 410 can relate to an associated item 412 that is determined to be considered for a purchase associated with shopper entity 414. By way of illustration, item description data 410 can include freeform, generic, or informal references to associated items 412 such as, e.g., “one pound of salmon,” “salad dressing,” or the like.

In some embodiments, shopper entity 414 can be shopper 214 with no/low vision detailed in connection with FIG. 2. Thus, item description data 410 can be received in the form of a Braille communication input, a voice communication input, or another suitable form.

As indicated at reference numeral 416, device 416 can interface with a server device such as store server 218 that is associated with a vendor entity 418. Vendor entity 418 can be one that offers products 432 for sale at a physical store location. As noted, store server 218 can comprise digital twin 220, which can be leveraged according to the disclosed techniques. For example, digital twin 220 can be indicative of a virtual representation of the physical store location and can comprise at least store location data 420 for a product 432 offered for sale at the physical store location.

At reference numeral 422, device 400 can perform matching procedure 424. In response to matching procedure 424, as indicated at reference numeral 426, device 400 can generate shopping list data 428. For instance, shopping list data 428 can be generated by iteratively matching a respective instance of item description data 410 to an associate product identifier 430 that is, for example, retained by digital twin 220 and/or store server 218. Product identifier 430 can be configured to indicate or identify a product from among products 432 that are offered for sale at the physical store location. In other words, a unique product 432 can be matched to each item 412 included in item description data 410.

At reference numeral 433, device 400 can perform navigation procedure 434. As indicated at reference numeral 436, navigation procedure 434 can communicate, via interface device 202, directions 440. Directions 440 can comprise navigation or guidance with the physical store location to the product 432. Such can be derived or determined from a current in-store location of shopper entity 414 and store location data 410 specific to product 432 that is retained by digital twin 220.

Turning now to FIG. 5, a schematic block diagram 500 is depicted illustrating additional aspects or elements of the example device 400 that can provide enhanced accessibility for in-store shoppers by dynamically generating a shopping list and an associated in-store navigation route to products of the shopping list in accordance with certain embodiments of this disclosure. For example, reference numerals 502-520 can relate to additional aspects or elements associated with matching procedure 424, reference numerals 522-528 can relate to additional aspects of navigation procedure 434, and reference numerals 532-542 can relate to a verification procedure 530 that be implemented in connection with a point of sale transaction to, e.g., determine whether product 432 is among the presented products that were presented for purchase via the point of sale transactions.

At reference numeral 502, device 400 can provide various input 504 to LLM 506 or to another suitable AI model. Input 504 can comprise, for example, item description data 410, all or a portion of digital twin data 508, such as any suitable data relating to products 432 that are offered for sale at the physical store location, various preferences 510 that relate to shopper entity 414 preferences or historical patterns.

In response, as indicated at reference numeral 512, LLM 506 can provide output 514. Output 514 can comprise one or more product identifiers 430 that can be aggregated to generate shopping list data 428. Furthermore, in some embodiments, output 514 can comprise one or more alternative products 516. As an example, alternative product 516 can be one that was not initially selected (e.g., based on preferences 510 or the like), but is nonetheless determined to be potentially desirable for shopper entity 414.

For example, suppose in response to item description data 410 that indicates “salad dressing”, LLM 506 and/or device 400 matches that instance to a product identifier 430 associated with a “12 ounce bottle of value brand ranch salad dressing”, potentially based on preference 510. However, further suppose that a different brand of ranch salad dressing is currently on sale, selling at 30% off. As another example, a different type of salad dressing (e.g., Caesar dressing rather than ranch dressing) might be identified as a potential alternative product because shopping list data 428 comprises product identifiers 430 for other products 432 (e.g., spinach and feta cheese) that are determined to pair well with Caesar dressing. Such a determination can be indicated by a third party authority and/or determined by LLM 506 or device 400 based on any suitable product pairing data.

At reference numeral 518, in response to output 514 received from LLM 506, device 400 can present information 520. Information 520 can be presented via interface device 202 and can comprise information about the alternative product (e.g., indicated by alternative product ID 516) and information about product that may be switched with the alternative product. For example, information 520 that is presented can be, e.g., “While you normally purchase value brand ranch dressing, today there is a promotion for new age brand ranch dressing which is being offered at 30% less than the value brand price. According to customer feedback, both brands have a similar flavor profile.” As another example, information 520 can be, e.g., “Although you normally purchase ranch dressing, we note that you are also buying spinach and feta cheese. According to ‘Cooking Digest’ magazine, Caesar dressing works especially with these ingredients and is favored over ranch dressing for salads when such ingredients are handy. Furthermore, there is a promotion on olives that ‘Cooking Digest’ magazine also recommends with salads should you want to add those to your shopping list.”

At reference numeral 522, potentially as part of navigation procedure 434, device 400 can select any one of various algorithms or a selected technique 524 to determine directions 440. For the selection, device 400 can leverage preferences 510 or other suitable data, as well as store layout 302 information, product placement 304 information, or other suitable information retained in digital twin 220 or otherwise.

FIG. 6A, which can now be referenced, illustrates a schematic block diagram 600A showing several potential examples of selected technique 524 in accordance with certain embodiments of this disclosure. By way illustration, selected technique 524 can be a shortest distance technique 602 that seeks to minimize or reduce the total distance traveled within the physical store location in order to collect all products 432 indicated by shopping list data 428. As another example, selected technique 524 can be an accessibility accommodation technique 604. Accessibility accommodation technique 604 leverage accessibility equipment or infrastructure (e.g., favor wider aisles over narrow ones, . . . ) in order to generate directions 440.

In some embodiments, selected technique 524 can be a store department technique 606. Store department technique 606 can order the collection of products 432 by store department (e.g., clothing, hardware, groceries, . . . ), which can be indicated in digital twin 220. In some embodiments, selected technique 524 can be a product type technique 608. Product type technique 608 can order the collection of products 432 by a type associated with a given product 432 (e.g., collect food type items last), which can be indicated in digital twin 220.

In some embodiments, selected technique 524 can be a packing preference technique 610. Packing preference technique 610 can order the collection of products 432 by packing preference (e.g., refrigerated items and frozen items after dry goods, . . . ), which can be indicated in digital twin 220. In some embodiments, selected technique 524 can be a weight/fragility technique 612. Weight/fragility technique 612 can order the collection of products 432 by a weight metric or a fragility metric (e.g., heavy or bulky items before light items, fragile items last, . . . ), which can be indicated in digital twin 220. It is understood that multiple different collection techniques can be utilized concurrently or in sequence with all or a portion of products indicated by shopping list data 428.

Still referring to FIG. 5, at reference numeral 526, device 400 can present directions 440 and, in some embodiments, device 400 can present information 528. As indicated, directions 440 and information 528 can be presented in a form that accommodates a person with no or low vision such as by audible means or by tactile means. Information 528 can be any suitable information in addition to directions 440. Generally, information 528 can be presented prior to directions 440, which is further explained in connection with FIG. 6B.

While still referring to FIG. 5, but turning now as well to FIG. 6B, a schematic block diagram 6B is depicted illustrating several potential examples of information 528 in accordance with certain embodiments of this disclosure. For example, prior to presenting directions 440 to a particular product 432 (e.g., the first or next product 432 indicated by shopping list data 428), device 400 can present a description of the next product, which is indicated at reference numeral 620. Such can operate to confirm for shopper entity 414 the next product to be collected.

At reference numeral 622, information 528 can include a description of selection criterion 622. For example, such can indicate the reasons (e.g., historical purchase history, preferences 510, . . . ) why a particular product identifier 430 for value brand ranch dressing was selected from among multiple other potential product identifiers 430 in response to item description data 428 that simply indicated “salad dressing”.

At reference numeral 624, information 528 can include a description of product access. For example, such can indicate where in the aisle a given product 432 is located (e.g., top shelf, . . . ), whether aid is available for collecting the product 432 or the like. At reference numeral 626, information 528 can include a verification that shopper entity 414 continues to desire to collect the product 432 and/or whether shopper entity 414 instead chooses to remove or change the next product to a different product.

Still referring to FIG. 5, generally after navigation procedure 434 is completed, device 400 can perform a verification procedure 530, potentially in connection with a point of sale transaction. For example, at reference numeral 532, device 400 can receive point of sale data 534 (e.g., a listing of all the products that were presented during checkout). At reference numeral 536, device 400 can compare point of sale data 534 to shopping list data 428. Based on this comparison, at reference numeral 538, device 400 can determine whether a missing product 540 exists or determine whether an errant product 542 exists.

Missing product 540 can exist when a product 432 of shopping list data 428 is not among the presented products that were processed during the point of sale transaction. Errant product 542 can exist when a product 432 that is not included in shopping list data 428 is nonetheless presented during the point of sale transaction. Such can be determined based at least part on store location data 420. For example, it can be determined that a given missing product 540 (e.g., a product 432 included in shopping list data 428, but not among the presented products) is located on the shelves in close proximity to the errant product 442 (e.g., a product 432 not included in shopping list data 428, but was among the presented products). Determination of missing product 540 or errant product 540 can be advantageous, especially for persons having no or low vision who sometimes cannot as readily verify shopping cart contents.

### Example Methods

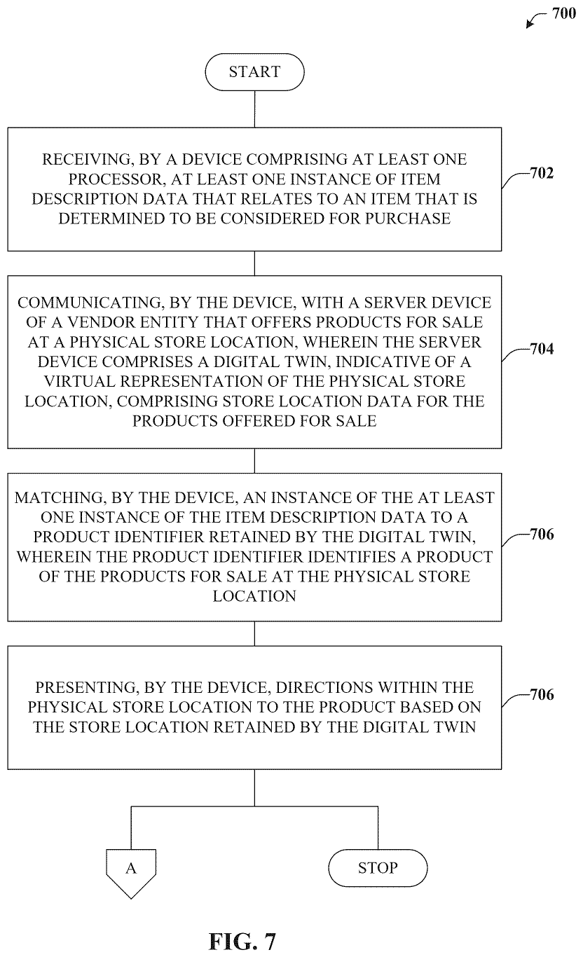

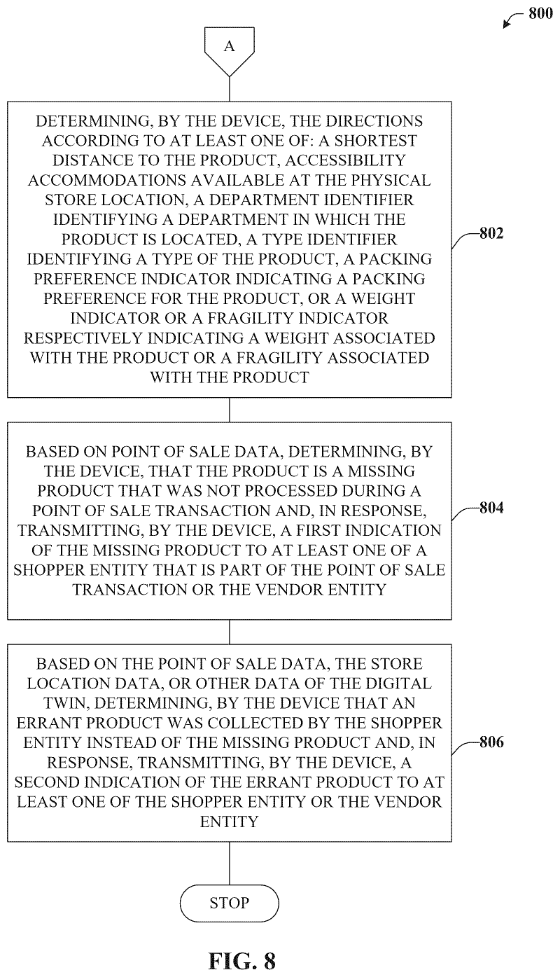

FIGS. 7 and 8 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 7, exemplary method 700 is depicted. Method 700 can provide enhanced accessibility for in-store shoppers by dynamically generating a shopping list and an associated in-store navigation route to products of the shopping list in accordance with certain embodiments of this disclosure. While method 700 describes a complete method, in some embodiments, method 700 can include one or more elements of method 800, reached via insert A, as discussed at FIG. 8.

At reference numeral 702, a device comprising at least one processor can receive at least one instance of item description data. Each given instance of item description data can relate to an item that is determined to be considered for purchase. Hence, item description data can represent an item list, e.g., typically describing in a generic or high-level form them items sought for purchase.

At reference numeral 704, the device can communicate with a server device of a vendor entity that offers products for sale at a physical store location. The server device can comprise a digital twin and associated information. The digital twin can be indicative of a virtual representation of the physical store location, comprising at least store location data for the products offered for sale.

At reference numeral 706, the device can match an instance of the at least one instance of the item description data to a product identifier retained by the digital twin. The product identifier can be configured to identify a product from among the products for sale at the physical store location. Hence, item description data can be dynamically matched to specific products sold at the store.

At reference numeral 708, the device can present directions within the physical store location to the product based on the store location retained by the digital twin. Method 700 can terminate in some embodiments, or proceed to insert A in other embodiments, which is further detailed in connection with FIG. 8.

Turning now to FIG. 8, exemplary method 800 is depicted. Method 800 can provide for additional elements or functionality relating to enhanced accessibility for in-store shoppers by dynamically generating a shopping list and an associated in-store navigation route to products of the shopping list in accordance with certain embodiments of this disclosure.

For example, at reference numeral 802, the device introduced in connection with FIG. 7 can determine the directions according to at least one of multiple different routing techniques. These multiple different routing techniques can leverage or include, for example, a shortest distance to the product, accessibility accommodations available at the physical store location, a department identifier identifying a department in which the product is located, a type identifier identifying a type of the product, a packing preference indicator indicating a packing preference for the product, or a weight indicator or a fragility indicator respectively indicating a weight associated with the product or a fragility associated with the product.

A reference numeral 804, based on point of sale data, the device can determine that the product is a missing product that was not processed during a point of sale transaction. Furthermore, in response to the identification of the missing product, transmitting, by the device, a first indication of the missing product to at least one of a shopper entity that is part of the point of sale transaction or the vendor entity.

A reference numeral 806, based on point of sale data, the store location data, or other data of the digital twin, the device can determine that the product is an errant product was collected instead of the missing product. Furthermore, in response to the determination that the product is an errant product, the device can transmit a second indication of the errant product to at least one of the shopper entity or the vendor entity.

### Exmample Operating Environments

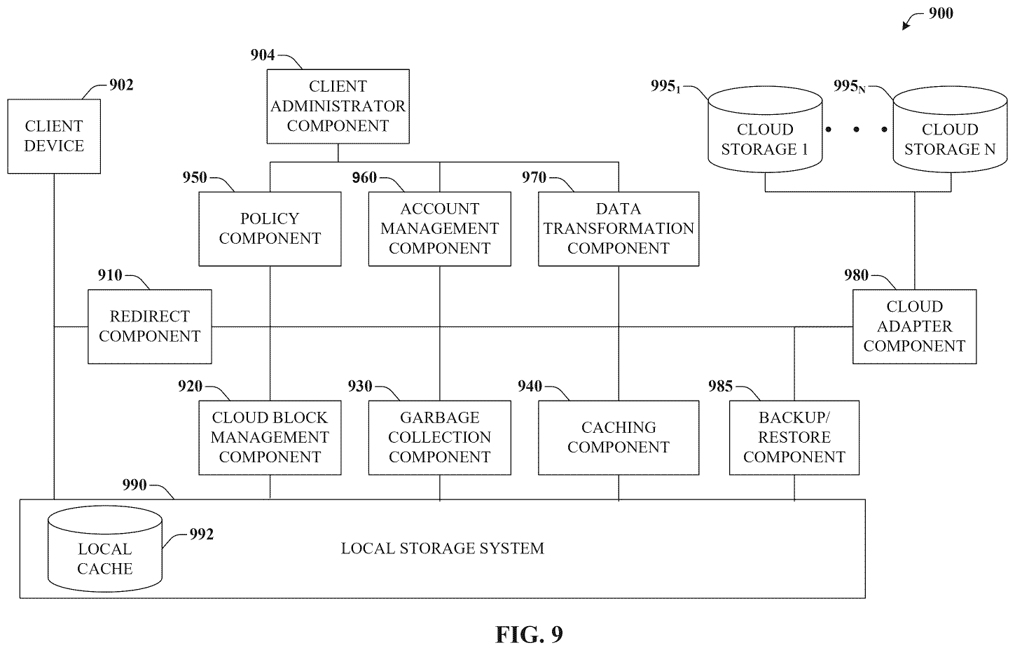

To provide further context for various example embodiments of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with example embodiments described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system such as an EMC Isilon Cluster or Dell PowerScale Cluster that operates under OneFS operating system or another suitable operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 995₁ and cloud storage N 995_{N}, where N is a positive integer. It can be appreciated that multiple cloud storage locations can be used for storage including multiple accounts within a single cloud storage location as more fully described in implementations of this disclosure. Further, a backup/restore component 985 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on a list of mappings that the cloud block management component 920 manages. For example, each stub can be associated with an account, and the cloud block management component 920 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 985 can transfer a copy of the files within the local storage system 990 to another cluster (e.g., target cluster). Further, the backup/restore component 985 can manage synchronization between the local storage system 990 and the other cluster, such that, the other cluster is timely updated with new and/or modified content within the local storage system 990.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various example embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
receiving, via an interface, at least one instance of item description data that relates to an item that is determined to be considered for a purchase associated with a shopper entity;
interfacing with a server device associated with a vendor entity that offers products for sale at a physical store location, wherein the server device comprises a digital twin, indicative of a virtual representation of the physical store location, the digital twin comprising store location data for the products offered for sale;
generating shopping list data in response to a matching procedure that iteratively matches respective instances of the at least one instance of the item description data to a product identifier retained by the digital twin, wherein the product identifier identifies a product of the products for sale at the physical store location; and
performing a navigation procedure that communicates, via the interface, directions within the physical store location to the product based on the store location retained by the digital twin.

2. The device of claim 1, wherein the shopper entity is a person with a vision impairment and the interface is configured to enhance a non-visual aspect of communication to mitigate the vision impairment.

3. The device of claim 1, wherein the item description data is communicated to the interface as a Braille communication or a voice communication.

4. The device of claim 1, wherein the matching procedure uses an output from a large language model to match the item description data, as input to the large language model, to the product identifier, as the output.

5. The device of claim 1, wherein the matching procedure selects from among multiple matching products, of the products, that match the item description data based on at least one of a preference associated with the shopper entity or selection input received from the shopper entity.

6. The device of claim 1, wherein the matching procedure further comprises, in response to identifying an alternative product that differs from the product matched to the item description data, presenting, via the interface, first information about the alternative product and second information about the product.

7. The device of claim 1, wherein the navigation procedure further comprises determining the directions according to at least one of: a shortest distance for the shopping list data, accessibility accommodations available at the physical store location, department associated with the product of the shopping list data, type of the product of the shopping list data, a packing preference for the shopping list data, or a weight or a fragility of the product of the shopping list data.

8. The device of claim 1, wherein the navigation procedure further comprises, prior to communicating the direction, presenting, via the interface, at least one of:
a first description of the product;
a second description as to why the product was selected in response to the item description data;
a third description of access to the product; or
a verification request that requests a verification that the directions to the product are to be provided or whether the product is to be changed or removed from the shopping list data.

9. The device of claim 1, wherein the directions are communicated to the shopper entity in a tactile manner.

10. The device of claim 1, wherein the operations further comprise, in response to a point of sale procedure that processes presented products for purchase, determining whether the product is among the presented products.

11. The device of claim 10, wherein the operations further comprise, in response to the product being determined not to be among the presented products, generating a notification to at least one of the server device or the shopper entity that the product was not presented at point of sale or an incorrect product was presented at the point of sale.

12. A method, comprising:
receiving, by a device comprising at least one processor, at least one instance of item description data that relates to an item that is determined to be considered for purchase;
communicating, by the device, with a server device of a vendor entity that offers products for sale at a physical store location, wherein the server device comprises a digital twin, indicative of a virtual representation of the physical store location, comprising store location data for the products offered for sale;
matching, by the device, an instance of the at least one instance of the item description data to a product identifier retained by the digital twin, wherein the product identifier identifies a product of the products for sale at the physical store location; and
presenting, by the device, directions within the physical store location to the product based on the store location retained by the digital twin.

13. The method of claim 12, further comprising, determining, by the device, the directions according to at least one of: a shortest distance to the product, accessibility accommodations available at the physical store location, a department identifier identifying a department in which the product is located, a type identifier identifying a type of the product, a packing preference indicator indicating a packing preference for the product, or a weight indicator or a fragility indicator respectively indicating a weight associated with the product or a fragility associated with the product.

14. The method of claim 12, further comprising, based on point of sale data, determining, by the device, that the product is a missing product that was not processed during a point of sale transaction and, in response, transmitting, by the device, a first indication of the missing product to at least one of a shopper entity that is part of the point of sale transaction or the vendor entity.

15. The method of claim 14, further comprising, based on the point of sale data, the store location data, or other data of the digital twin, determining, by the device that an errant product was collected by the shopper entity instead of the missing product and, in response, transmitting, by the device, a second indication of the errant product to at least one of the shopper entity or the vendor entity.

16. A non-transitory computer-readable medium comprising instructions that, in response to execution, cause a system comprising a processor to perform operations, comprising:
receiving, via an interface, at least one instance of item description data that relates to an item that is determined to be considered for purchase;
interfacing with a server device of a vendor entity that offers products for sale at a physical store location, wherein the server device comprises a digital twin, indicative of a virtual representation of the physical store location, the digital twin comprising store location data for the products offered for sale;
matching an instance of the at least one instance of the item description data to a product identifier retained by the digital twin, wherein the product identifier identifies a product of the products for sale at the physical store location; and
communicating, via the interface, directions within the physical store location to the product based on the store location retained by the digital twin.

17. The non-transitory computer-readable medium of claim 16, wherein the item description data is communicated to the interface as a Braille communication or a voice communication.

18. The non-transitory computer-readable medium of claim 16, wherein the operations further comprise determining the directions based on at least one of: a shortest distance to the product, accessibility accommodations available at the physical store location, a department in which the product is situated, a product type of the product, a packing preference for the product, a weight metric previously measured for the product, or a fragility metric previously measured for the product.

19. The non-transitory computer-readable medium of claim 16, wherein the operations further comprise, in response to a point of sale transaction that processes presented products for purchase, determining whether the product is among the presented products.

20. The non-transitory computer-readable medium of claim 19, wherein the operations further comprise, in response to the product being determined not to be among the presented products, generating a notification to at least one of the server device or a user device corresponding to a shopper entity that is part of the point of sale transaction that the product was not presented at point of sale or an incorrect product was presented at the point of sale.
